(19) United States
(12) Patent Application Publication
(10) Pub. No.: US 2025/0229294 A1
(43) Pub. Date: Jul. 17, 2025

(54) METHOD AND SYSTEM FOR RECOVERING WOOD PARTICLES FROM A WOOD-BASED FEEDSTOCK COMPRISING BARK

(71) Applicant: UPM-Kymmene Corporation, Helsinki (FI)

(72) Inventor: Vilho NISSINEN, Helsinki (FI)

(21) Appl. No.: 18/853,970

(22) PCT Filed: Mar. 13, 2023
(86) PCT No.: PCT/FI2023/050137

§ 371 Date: Oct. 3, 2024

(30) Foreign Application Priority Data
Apr. 5, 2022 (FI) 20225294

(51) Int. Cl. B07B 1/00

(52) U.S. Cl. CPC B07B 1/00; B07B 2201/04

(57) ABSTRACT

A method for recovering wood particles from a wood-based feedstock comprising bark is disclosed. A system for recovering wood particles from a wood-based feedstock comprising bark is further disclosed. A product comprising wood particles formed using the method of the present disclosure is also disclosed. Finally, the use of wood particles formed in the method according to the present disclosure is disclosed.

### TECHNICAL FIELD

The present disclosure relates to a method for recovering wood particles from a wood-based feedstock comprising bark. The present disclosure further relates to a system for recovering wood particles from a wood-based feedstock comprising bark. The present disclosure also relates to a product comprising wood particles formed using the method of the present disclosure. Finally, the present disclosure relates to the use of wood particles formed in the method according to the present disclosure.

### BACKGROUND

Prior to being used in various processes, wood-based raw material, i.e. logs, must be debarked to produce a raw material comprising as little as possible of undesired materials such as bark. Debarking in commercial settings is usually carried out using various mechanical debarkers that strip or remove a certain thickness of material from the surface of the logs. The downside of mechanical debarking is that the layer removed from the log will, in addition to bark, also include wood, which can lead to significant losses of valuable wood raw material if the wood included in the bark fraction is not recovered.

### SUMMARY

A method for recovering wood particles from a wood-based feed-stock comprising bark is disclosed. The method may comprise:
a) providing the wood-based feedstock comprising bark,
b) screening the wood-based feedstock comprising bark to separate wood particles from bark particles, and
c) recovering the wood particles to form a wood stream and a screened wood-based feedstock comprising bark.

A product comprising wood particles produced by the disclosed method is disclosed.

Use of the wood particles formed using the disclosed method or the disclosed product is disclosed.

A system for screening a wood-based feedstock comprising bark to recover wood particles included in the wood-based feedstock comprising bark is disclosed. The system may comprise at least one screening means for separating the bark particles from the wood particles to form a wood stream and a screened wood-based feedstock comprising bark.

### BRIEF DESCRIPTION OF THE DRAWINGS

The accompanying drawings, which are included to provide a further understanding of the embodiments and constitute a part of this specification, illustrate various embodiments. In the drawings:

FIG. 1 presents a flow chart of one embodiment of the method for recovering wood particles from a wood-based feedstock comprising bark.

FIG. 2 presents a flow chart of one embodiment of the method for recovering wood particles from a wood-based feedstock comprising bark.

FIG. 3 presents the classification and sorting of wood chips according to the SCAN-CM 40:01 method.

FIG. 4 presents bark chips formed in mechanical debarking of beech and ash.

FIG. 5 presents the thickness of beech bark as a function of the diameter of the wood.

### DETAILED DESCRIPTION

A method for recovering wood particles from a wood-based feedstock comprising bark is disclosed, wherein the method comprises screening the wood-based feedstock.

In one embodiment, the method may comprise:
a) providing the wood-based feedstock comprising bark,
b) screening the wood-based feedstock comprising bark using at least one screening means to separate wood particles from bark particles, and
c) recovering the wood particles form a wood stream.

In one embodiment, the method comprises recovering wood particles from a wood-based feedstock comprising bark, wherein the method comprises:
a) providing the wood-based feedstock comprising bark,
b) screening the wood-based feedstock comprising bark to separate wood particles from bark particles, and
c) recovering the wood particles to form a wood stream and a screened wood-based feedstock comprising bark.

In one embodiment, the method for recovering wood particles from a wood-based feedstock comprising bark comprises
d) screening the screened wood-based feedstock comprising bark to form a second wood stream and a second screened wood-based feedstock comprising bark, and
e) combining the wood stream and the second wood stream to form a combined wood stream.

In one embodiment, the method comprises recovering wood particles from a wood-based feedstock comprising bark, wherein the method comprises:
a) providing the wood-based feedstock comprising bark,
b) screening the wood-based feedstock comprising bark to separate wood particles from bark particles,
c) recovering the wood particles to form a wood stream and a screened wood-based feedstock comprising bark,
d) screening the screened wood-based feedstock comprising bark to form a second wood stream and a second screened wood-based feedstock comprising bark, and
e) combining the wood stream and the second wood stream to form a combined wood stream.

Providing the wood-based feedstock in a) may comprise subjecting a wood-based raw material to a mechanical treatment selected from debarking, chipping, dividing, cutting, beating, grinding, crushing, splitting, screening, and/or washing the wood-based raw material to form the wood-based feedstock. In certain embodiments, providing the wood-based feedstock in a) may comprise subjecting a wood-based raw material to a mechanical treatment selected from debarking and/or chipping. In certain embodiments, the wood-based raw material may be wood logs, wood stumps, wood blocks, or any combination thereof. In one embodiment, the wood-based raw material is logs. During the mechanical treatment e.g. wood logs can be debarked and/or wood chips can be formed.

In certain embodiments, the wood-based feedstock comprising bark is separated into recovered wood particles and bark particles.

In one embodiment, the wood-based feedstock comprising bark is formed by debarking a wood-based raw material to form a wood-based feedstock comprising bark and a debarked wood-based raw material. In one embodiment, the wood-based feedstock comprising bark is formed by debarking logs to form a wood-based feedstock comprising bark and debarked logs. In one embodiment, the debarked wood-based raw material is debarked logs.

Providing the wood-based feedstock may comprise purchasing the wood-based feedstock. The purchased wood-based feedstock may comprise purchased wood-based feedstock comprising bark that originate from wood-based raw material.

In certain embodiments, the wood-based raw material is hardwood, softwood, or any combination thereof. The wood-based raw material or wood-based feedstock may, e.g., originate from pine, poplar, beech, aspen, spruce, eucalyptus, ash, or birch. The wood-based raw material or wood-based feedstock may also be any combination or mixture of these. The wood-based raw material or wood-based feedstock may be broadleaf wood. The broadleaf wood may be selected from a group consisting of beech, birch, ash, oak, maple, chestnut, willow, poplar, and any combination of mixture thereof.

In certain embodiments, the wood-based raw material may be logs. In certain embodiment, the length of the logs is 0.5-8 m, or 1-6 m, or 2-4 m. In certain embodiments, the average diameter of the logs of the wood-based raw material may be 10-80 cm, or 20-60 cm.

In certain embodiments, the recovered wood particles are oversize wood chips and/or overthick wood chips as specified by SCAN-CM 40:01. In certain embodiments, the bark particles are large accept chips, small accept chips, pin chips, and/or fines as specified by SCAN-CM 40:01.

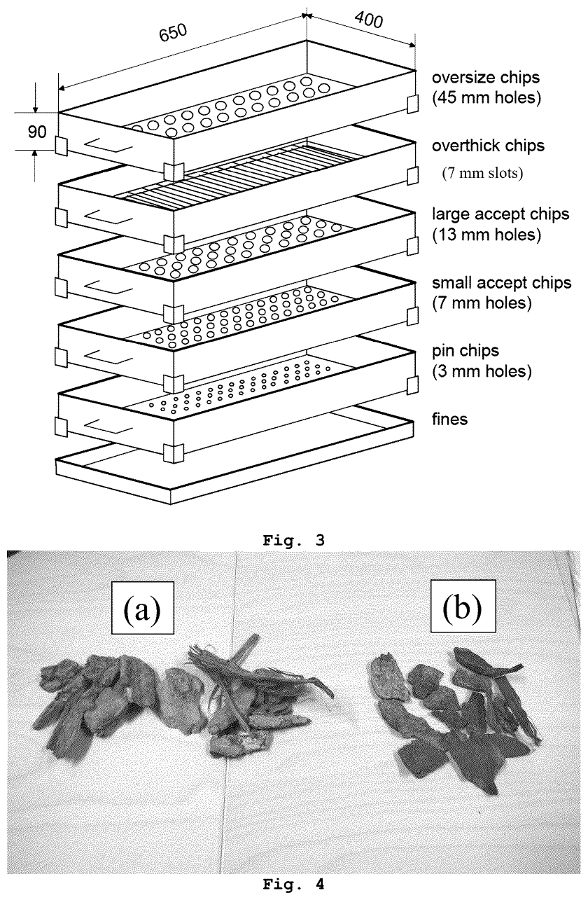

The standard SCAN-CM 40:01 (version revised 2001) describes a manner for the classification of wood chips, wherein a sample of wood chips is placed on the top screen of a stack of five screen trays and a fines tray (see FIG. 3). The screens have holes or slots of specified dimensions, and the stack is kept in a reciprocating motion. After a specified time, the screening is stopped, and the six classes obtained are weighed separately. The size of each class is its mass, expressed as a percentage of the total mass of all six classes.

The inventors surprisingly found that it is possible to separate bark particles contained in a wood-based feedstock comprising bark from wood particles by screening the wood-based feedstock comprising bark with a suitable arrangement of screening means.

As used herein, the term “screening means” refers to a means for screening the wood-based feedstock based on particle size. Non-limiting examples of screening means are plate screens, disc screens, hole screens, slot screens, bar slot screens, and wire slot screens.

As is known to a person skilled in the art, a plate screen comprises a smooth, plate-like, surface in which holes or perforations have been made. The holes or perforations in the plate of the plate screen may be e.g. round, square, elliptical, rhomboid, or triangular in shape. The size and shape of the holes or perforations should be selected according to the dimensions of the particles to be screened. A disc screen comprises a series of shaft driven assemblies with profiled discs mounted at regular spacings. The discs from one shaft interleaf with those on the adjacent shafts, creating openings or slots between the discs and the shafts. The rotating discs move the material through the screen and the material is screened according to the size of the slots. In certain embodiments a slot screen comprises slots through which particles of a desired size, width, and/or length may pass. In certain embodiments, a slot screen may be a bar slot screen where the slots are constructed using metal bars or rods. In certain embodiments, a slot screen may be a wire slot screen where the slots are constructed using metal wires.

In certain embodiments, the at least one screening is performed using a disc screen, a plate screen, or a slot screen. In certain embodiments, the slot screen may be a bar slot screen or a wire slot screen.

In certain embodiments, the size of the holes in a plate screen may be defined according to the size of particles that are retained on top of the screen. As a non-limiting example, if the hole size (or diameter) is defined as approximately 45 mm, particles larger than approximately 45 mm are retained on the screen and particles smaller than approximately 45 mm are allowed to pass through the holes of the screen, irrespective of the shape of the holes in the screen. In certain embodiments, the hole size may be 40 mm-50 mm, or 43 mm-48 mm, or approximately 45 mm.

A person skilled in the art will be able to select the size and shape of the holes in a plate screen based on the size and shape of the bark particles which is determined case-by-case for different combinations of debarkers and types of wood. FIG. 4 presents examples of the shape of bark particles formed in the debarking of ash and beech. In FIG. 3, a) is ash bark, the particles or chips of which are more round and thicker. In FIG. 3., b) is beech bark, the particles or chips of which are plate-like and thinner.

In one embodiment, the screen used for screening the wood-based feedstock comprising bark allows essentially all of the bark particles to pass through the screen. In one embodiment, the screen used for screening the wood-based feedstock comprising bark allows at least 95% of the bark particles to pass through the screen. In one embodiment, the screened wood-based feedstock comprising bark comprises at least 95 weight-% of bark particles from the wood-based feedstock comprising bark. In one embodiment, the second screened wood-based feedstock comprising bark comprises at least 95 weight-% of bark particles from the wood-based feedstock comprising bark. In certain embodiments, the size of the holes in a plate screen are selected to be approximately 110-120% of the largest dimension of the bark particles. The size of the bark particles can be easily determined by measuring them from the bark wood-based feedstock comprising bark to be screened.

In one embodiment, the recovered wood particles comprise bark in an amount of less than 5 weight-%, or less than 3 weight-%, or less than 1 weight-%, or less than 0.5 weight-%, or less than 0.25 weight-% of the recovered wood particles after separation from the bark particles.

In one embodiment, the bark particles comprise wood in an amount of less than 50 weight-% of the bark fraction after separation from the wood particles.

In one embodiment, the screening of the wood-based feedstock comprising bark is performed by passing the wood-based feedstock comprising bark through a series of screens or screening means selected so that the particles retained on the screen are successively smaller than those retained on the previous screen. In one embodiment, the screening of the wood-based feedstock comprising bark is performed by passing the wood-based feedstock comprising bark through a series of screens or screening means in which the holes and/or slots of each individual screening means are successively smaller than those of the previous screening means.

In one embodiment, the screening comprises using plate screens, slot screens, and/or disc screens. In certain embodiments, the screening is performed using one screening means, two screening means, or three screening means. In certain embodiments, the screening is performed using at least one screening means.

In one embodiment, in a method according to the present disclosure the screening in b) comprises at least one screening.

In one embodiment, a method according to the present disclosure comprises at least a first screening and a second screening performed after the first screening.

In certain embodiments, one or more screening means may be arranged in a sequence to allow screening of the wood-based feedstock comprising bark in more than one sequential screening step. In one embodiment, the one or more screening means may be arranged vertically so that the first screening means is above the second screening means. In one embodiment, the one or more screening means may be arranged horizontally, so that the screened product from the first screening means is conveyed from the first screening means to the second screening means using e.g. a conveyor belt, a screw, or other similar means known to a person skilled in the art.

In one embodiment, the wood loss in the debarking process is less than 10 weight-%, or less than 8 weight-%, or less than 6 weight-%, or less than 4 weight-%, or less than 3 weight-%, or less than 2 weight-%, or less than 1 weight-% compared to the total content of wood in the wood-based raw material prior to the mechanical treatment.

In one embodiment, the debarker is a knife debarker, a drum debarker, or a rotary debarker.

A product comprising wood particles produced according to the method of the present disclosure is disclosed. In one embodiment, the wood stream comprises wood particles formed in the method of the present disclosure.

The use of wood particles formed according to the method of the present disclosure or a product comprising wood particles formed according to the method of the present disclosure is disclosed. A product comprising wood particles produced according to the method of the present disclosure may be used in any suitable use known a person skilled in the art. Non-limiting examples of suitable uses are for the production of pulp, for the production of paper, for the production of bioethanol, and for the production of other chemicals or intermediates. In one embodiment, the recovered wood particles may be returned upstream in the processing of the wood-based raw material such as fed into a chipping process. As will be readily obvious to a person skilled in the art, some uses may require additional treatment or process steps to make the wood particles suited for further use.

A system for screening a wood-based feedstock comprising bark to recover wood particles included in the wood-based feedstock comprising bark is disclosed. In one embodiment, a system according to the present disclosure comprises at least one screening means for separating the wood particles from the bark particles to form a wood stream and a screened wood-based feedstock comprising bark.

In one embodiment, the system comprises a first screening means for separating the wood particles from the bark particles to form a wood stream and a screened wood-based feedstock comprising bark.

In one embodiment, the system comprises a second screening means for screening the screened wood-based feedstock comprising bark to form a second wood stream and a second screened wood-based feedstock comprising bark.

In one embodiment, the system comprises a first screening means for separating the wood particles from the bark particles to form a wood stream and a screened wood-based feedstock comprising bark and a second screening means for screening the screened wood-based feedstock comprising bark to form a second wood stream and a second screened wood-based feedstock comprising bark.

In one embodiment, the system for screening a wood-based feedstock comprising bark comprises a screening means with slot openings adjusted to approximately 120% of the largest dimension of the bark particles for separating the bark particles from the wood particles. In one embodiment, the system for screening a wood-based feedstock comprising bark comprises one screening means with slot openings adjusted to approximately 110-120% of the maximum thickness of the bark for separating the bark particles from the wood particles. In one embodiment, the slot size of the at least one screening means may be approximately 110% of the thickness of the bark.

In one embodiment, the wood-based feedstock is formed in the debarking of wood-based raw material comprising logs, stumps, blocks, branches, or any combinations thereof.

In one embodiment, the system for screening a wood-based feedstock comprising bark comprises a plate screen. The plate screen comprises holes with a size of 40 mm-50 mm, or 43 mm-48 mm, or approximately 45 mm. In certain embodiments, the holes or perforations in the plate of the plate screen may be e.g. round, square, elliptical, rhomboid, diamond, or triangular in shape. In one embodiment, the system comprises a slot screen. The slot screen may have a slot size of 8 mm or less. In one embodiment, the system comprises a disc screen. In certain embodiments, the disc screen may have a slot size of 8×45 mm or less. The size of the hole or slot may be chosen or adjusted depending on the thickness of the bark on the wood-based raw material. In order to separate the wood particles from the wood-based feedstock comprising bark, the slot size should be larger than the thickness of the bark.

In one embodiment, the system comprises a screening means with a slot size or hole size adjusted according to the dimensions such as thickness of the bark in the wood-based feedstock comprising.

In certain embodiments, the system comprises at least one screening means. In certain embodiments, a system according to the present disclosure comprises at least one plate screen and at least one additional screening means.

In one embodiment, the system comprises a first screening means with a slot size or hole size of adjusted to the size of the bark particles so that all bark particles pass through the holes, and a second screening means with a slot size or hole size selected according to the thickness of the bark in the wood-based raw material or wood-based feedstock comprising bark. As a non-limiting example, a hole size of approximately 45 mm may be taken to refer to a diamond-shaped hole with sides measuring approximately 45 mm.

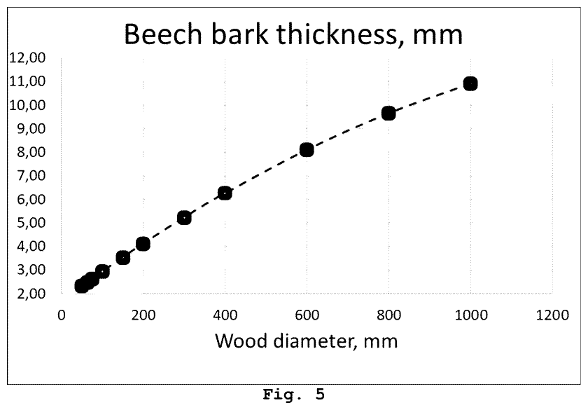

The thickness of the bark can be determined e.g. by measuring the thickness of a representative number of bark pieces collected from the wood-based feedstock comprising bark. When the thickness has been measured, the slot size is selected according to the thickest pieces of bark. In certain embodiments, the bark thickness may also be estimated based on the diameter of the logs of the wood-based raw material. As a non-limiting example, FIG. 5 presents the relationship between diameter of the log and bark thickness for beech. As will be obvious to a skilled person, the thickness of the bark should be determined on a case-by-case basis.

In one embodiment, the system comprises a first screening means with a slot size or hole size of approximately 110-120% of the largest dimension of the bark particles and a second screening means with a slot size or hole size adjusted according to the thickness of the bark in the wood-based raw material or wood-based feedstock comprising bark. In one embodiment, the first screening means comprises a plate screen with holes with a size of approximately 110-120% of the largest dimension of the bark particles and the second screening means comprises a slot screen arranged below the first plate screen with rods arranged to have slot size adjusted according to the thickness of the bark in the wood-based raw material or wood-based feedstock comprising bark.

In certain embodiments, the first screening means comprises a screen with holes with a size of 40 mm-50 mm, or 43 mm-48 mm, or approximately 45 mm. In certain embodiments, the second screening means comprises a slot screen arranged below the screening means with rods arranged to have slot size of approximately 7 or 8 mm.

In certain embodiments, the second screening means comprises a screen with a slot size or hole size adjusted according to the thickness of the bark in the wood-based raw material or wood-based feedstock comprising bark. In certain embodiments, the second screening means comprises a slot screen arranged below the first plate screen with rods arranged to have slot size adjusted according to the thickness of the bark in the wood-based raw material or wood-based feedstock comprising bark. In certain embodiments, the second screening means comprises a slot screen arranged below the screening means with rods arranged to have slot size of approximately 7 or 8 mm.

In one embodiment, the first screening means comprises a screen with holes with a size of 40 mm-50 mm, or 43 mm-48 mm, or approximately 45 mm and the second screening means comprises a slot screen arranged below the screening means with rods arranged to have slot size of approximately 7 or 8 mm.

In one embodiment, the first screening means comprises a screen with a hole size of 40 mm-50 mm, or 43 mm-48 mm, or approximately 45 mm and the second screening means comprises a screen with a slot size or hole size adjusted according to the thickness of the bark in the wood-based raw material or wood-based feedstock comprising bark. In one embodiment, the first screening means comprises a plate screen with holes with a size of 40 mm-50 mm, or 43 mm-48 mm, or approximately 45 mm and the second screening means comprises a slot screen arranged below the first plate screen with rods arranged to have slot size adjusted according to the thickness of the bark in the wood-based raw material or wood-based feedstock comprising bark. In one embodiment, the first screening means comprises a screen with holes with a size of 40 mm-50 mm, or 43 mm-48 mm, or approximately 45 mm and the second screening means comprises a slot screen arranged below the screening means with rods arranged to have slot size of approximately 7 or 8 mm.

In certain embodiments, one or more screening means may be arranged in a sequence to allow screening of the wood-based feedstock comprising bark in more than one sequential screening step. In one embodiment, the one or more screening means may be arranged vertically so that the first screening means is above the second screening means. In one embodiment, the one or more screening means may be arranged horizontally, so that the screened product from the first screening means is conveyed from the first screening means to the second screening means using e.g. a conveyor belt, a screw, or other similar means known to a person skilled in the art.

In one embodiment, the second screening means is arranged after or below the first screening means.

In one embodiment, the first screening means comprises a screen with a hole size of approximately 45×45 mm and the second screening means comprises a second screen with a slot size or hole size adjusted according to the dimensions of the bark particles in the wood-based raw material. In one embodiment, the first screening means comprises a plate screen with holes with a size of 40 mm-50 mm, or 43 mm-48 mm, or approximately 45 mm and the second screening means comprises a slot screen arranged below or after the first plate screen with rods arranged to have slot size adjusted according to the thickness of the bark in the wood-based raw material. In one embodiment, the first screening means comprises a plate screen with holes with a size of 40 mm-50 mm, or 43 mm-48 mm, or approximately 45 mm and the second screening means comprises a slot screen arranged below or after the first plate screen with bars or wires arranged to have slot size of approximately 7 or 8 mm. In one embodiment, the first screening means comprises a disc screen with holes with a size of 40 mm-50 mm, or 43 mm-48 mm, or approximately 45 mm and the second screening means comprises a slot screen arranged below or after the first plate screen with bars or wires arranged to have slot size of approximately 7 or 8 mm.

In one embodiment, the first screening means is a plate screen with holes with a size of approximately 45 mm and the second screening means arranged below the plate screen is a slot screen with bars or wires arranged to have slot size adjusted according to the thickness of the bark in the wood-based feedstock.

In one embodiment of a system according to the present disclosure, the purpose of the first screening means is to separate thin and long stick-like wood particles from the wood-based feedstock comprising bark to form a screened wood-based feedstock comprising bark. Simultaneously, the first screening will also separate thick stick-like wood particles as well as other large wood particles from the wood-based feedstock comprising bark.

Thus, the wood particles described above are retained on the first screen and the screened wood-based feedstock comprises bark and smaller wood particles. If a second screening means is arranged below or after the first screening means, the purpose of the second screening means is to separate remaining wood particles from the screened wood-based feedstock comprising bark. The wood particles separated from the wood-based feedstock comprising bark in both screenings can then be combined to form a fraction of wood particles. As the wood-based feedstock comprising bark will also comprise wood particles that are similar in size or smaller that the bark particles, the screened wood-based feedstock comprising bark and/or second screened wood-based feedstock comprising bark will also include some small wood particles.

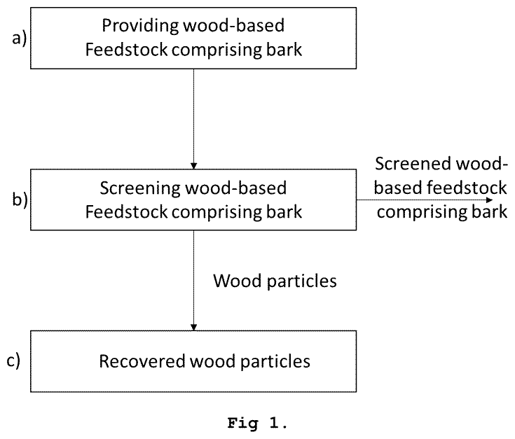

FIG. 1 presents a flow chart of one embodiment of the method for recovering wood particles from a wood-based feedstock comprising bark. In the embodiment of FIG. 1, the provided wood-based feedstock comprising bark (a) is screened (b) by a screening means. In the screening, wood particles are separated from bark particles and the wood particles recovered (c).

In certain embodiments, the second screening means arranged after or under the first screening means may be a disc screen, a slot screen, or a plate screen with rods arranged to have a slot size adjusted according to the thickness of the bark in the wood-based feedstock.

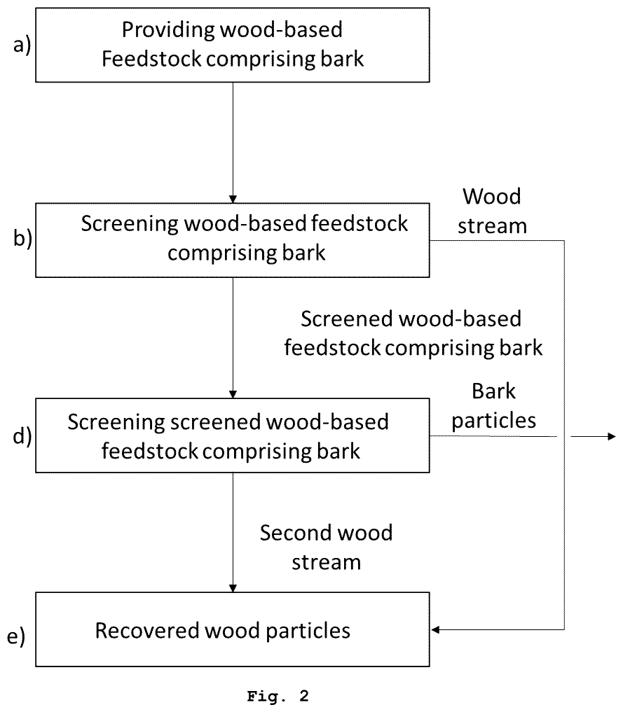

FIG. 2 presents a flow chart of one embodiment of the method for recovering wood particles from a wood-based feedstock comprising bark. In the embodiment of FIG. 2, the provided wood-based feedstock comprising bark (a) is screened (b) by two consecutive screening means. In the first screening, bark particles are separated to form a screened wood-based feedstock comprising bark. In the second screening, a screened wood-based feedstock comprising bark is screened to separate wood particles from bark particles and the wood particles are recovered (c).

The method described in the current specification has the added utility of increasing the total yield of wood from a wood-based raw material after debarking, thereby reducing the loss of wood in the debarking process.

### EXAMPLES

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example 1—Beech Bark

Logs of beech with a diameter of approximately 20-40 cm were debarked in a rotary debarker. The bulk density of the recovered bark fraction was approximately 241 kg/m³ when unpressed and approximately 326 kg/m³ when manually pressed.

The bark fraction recovered from the debarking was screened using a screening setup according to FIG. 3 and the resulting fractions analyzed for content of wood and bark.

TABLE 1

| | | Wood, | Wood, % of |
|---|---|---|---|
| Beech | Fraction, | % in | total wood |
| fractions | weight % | fraction | in bark |
| >hole 45 mm | 9.3 | 100.0 | 11.5 |
| Slot 7- | 29.2 | 100.0 | 39.1 |
| hole 45 mm | | | |
| Hole 13- | 23.7 | 54.0 | 17.1 |
| slot 7 mm | | | |
| Hole 7- 13 mm | 12.9 | 66.0 | 10.5 |
| Hole 3-7 mm | 11.0 | 71.0 | 9.9 |
| Hole <3 mm | 13.8 | 69.0 | 12.0 |

As can be seen, for beech tree wood (diameter 20-40 cm), the amount of the total wood recovered from the bark from debarking in the first two fractions was around 50%. This wood may be combined with the wood from the debarked logs for further use.

### Example 2—Ash Bark

Logs of ash with a diameter of approximately 20 cm were debarked in a rotary debarker. The bulk density of the recovered bark fraction was approximately 292 kg/m³ when unpressed and approximately 409 kg/m³ when manually pressed.

The bark fraction recovered from the debarking was screened using a screening setup according to FIG. 3 and the resulting fractions analyzed for content of wood and bark.

TABLE 1

| | | Wood, | Wood, % of |
|---|---|---|---|
| Ash | Fraction, | % in | total wood |
| fractions | weight % | fraction | in bark |
| >hole 45 mm | 3.3 | 100.0 | 4.8 |
| Slot 7- | 31.7 | 40.1 | 22.4 |
| hole 45 mm | | | |
| Hole 13- | 18.3 | 65.7 | 19.5 |
| slot 7 mm | | | |
| Hole 7-13 mm | 23.6 | 74.3 | 30.5 |
| Hole 3-7 mm | 11.8 | 75.0 | 13.7 |
| Hole < 3 mm | 11.2 | 47.0 | 9.0 |

As can be seen, for ash tree wood (diameter 20 cm), the amount of the total wood recovered in the first two fractions was around 27%. This wood may be combined with the wood from the debarked logs for further use.

The examples show that by screening, it is possible to recover a significant amount of wood particles from bark after debarking. Thus, the losses of the wood material may be diminished, and sourcing of wood may be decreased, leading to environmental benefits. The recovered wood particles are pure, free of bark and may be conducted to different processes utilizing such pure wood particles.

It is obvious to a person skilled in the art that with the advancement of technology, the basic idea may be implemented in various ways. The embodiments are thus not limited to the examples described above; instead, they may vary within the scope of the claims.

The embodiments described hereinbefore may be used in any combination with each other. Several of the embodiments may be combined together to form a further embodiment. A method, a product, or a system, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A method for recovering wood particles from a wood-based feed-stock comprising bark, wherein the method comprises:
a) providing the wood-based feedstock comprising bark;
b) screening the wood-based feedstock comprising bark to separate wood particles from bark particles; and
c) recovering the wood particles to form a wood stream and a screened wood-based feedstock comprising bark.

2. The method according to claim 1, wherein the method further comprises:
d) screening the screened wood-based feedstock comprising bark to form a second wood stream and a second screened wood-based feedstock comprising bark; and
e) combining the wood stream and the second wood stream to form a combined wood stream.

3. The method of claim 1, wherein the wood-based feedstock comprising bark is formed by debarking a wood-based raw material to form a wood-based feedstock comprising bark and debarked wood-based raw material.

4. The method of claim 1, wherein the screening in b) comprises at least one screening.

5. The method of claim 1, wherein the screening in b) comprises at least a first screening and a second screening performed after the first screening.

6. The method of claim 1, wherein the screened wood-based feedstock comprising bark comprises at least 95 weight-% of bark particles from the wood-based feedstock comprising bark.

7. The method of claim 1, wherein the at least one screening is performed using a disc screen, a plate screen, or a slot screen.

8. The method of claim 1, wherein the wood-based feedstock is hardwood, softwood, or any combination thereof.

9. The method of claim 1, wherein the wood-based raw material is logs.

10. The method of claim 1, wherein the length of the logs is 0.5-8 m.

11. The method of claim 1, wherein the recovered wood particles are oversize wood chips and/or overthick wood chips as specified by SCAN-CM 40:01.

12. The method of claim 1, wherein the bark particles are large accept chips, small accept chips, pin chips, and/or fines as specified by SCAN-CM 40:01.

13. The method of claim 1, wherein the recovered wood particles comprise bark in an amount of less than 5 weight-% of the recovered wood particles after separation from the bark particles.

14. The method of claim 1, wherein the screening of the wood-based feedstock comprising bark is performed by passing the wood-based feedstock comprising bark through a series of screens or screening means selected so that the particles retained on the screen are successively smaller than those retained on the previous screen.

15. The method of claim 1, wherein debarker is a knife debarker, a drum debarker, or a rotary debarker.

16. A product comprising wood particles produced by the method of claim 1.

17. Use of the wood particles formed using the method of claim 1.

18. A system for screening a wood-based feedstock comprising bark to recover wood particles included in the wood-based feedstock comprising bark wherein the system comprises at least one screening means for separating the wood particles from the bark particles to form a wood stream and a screened wood-based feedstock comprising bark.

19. The system according to claim 18, wherein the system comprises a first screening means for separating the bark wood particles from the wood bark particles to form a wood stream and a screened wood-based feedstock comprising bark.

20. The system according to claim 19, wherein the system comprises a second screening means for screening the screened wood-based feedstock comprising bark to form a second wood stream and a second screened wood-based feedstock comprising bark.

21. The system according to claim 18, wherein the system comprises at least one screening means with openings adjusted to approximately 120% of the largest dimension of the bark particles of the wood-based raw material for separating the bark particles from the wood particles.

22. The system according to claim 18, wherein the wood-based feedstock is formed in the debarking of wood-based raw material comprising logs, stumps, blocks, branches, or any combinations thereof.

23. The system according to claim 18, wherein the first screening means comprises a screen with a hole size of 40 mm-50 mm.

24. The system according to claim 20, wherein the second screening means comprises a screen with a slot size or hole size adjusted according to the thickness of the bark of the wood-based feedstock.

25. The system according to claim 20, wherein the second screening means is arranged after or below the first screening means.

26. The system according to claim 18, wherein the first screening means is a plate screen with holes with a size of approximately 45 mm and the second screening means arranged below the plate screen is a slot screen with bars or wires arranged to have slot size adjusted according to the thickness of the bark in the wood-based feedstock.
